(19) United States
(12) Patent Application Publication
(10) Pub. No.: US 2025/0253895 A1
(43) Pub. Date: Aug. 7, 2025

(54) METHODS FOR CONSTRUCTING AND CONFIGURING DIGITALLY CONTROLLABLE SCATTERER AND FOR PROVIDING FOCUSING BETWEEN NODES

(71) Applicant: HUAWEI TECHNOLOGIES CO., LTD., Shenzhen (CN)

(72) Inventors: Mustapha AMARA, Boulogne Billancourt (FR); Sami MEKKI, Boulogne Billancourt (FR); Mohamed KAMOUN, Boulogne Billancourt (FR); Melissa DUARTE GELVEZ, Boulogne Billancourt (FR)

(21) Appl. No.: 19/187,594

(22) Filed: Apr. 23, 2025

Related U.S. Application Data
(63) Continuation of application No. PCT/EP2022/079562, filed on Oct. 24, 2022.

(51) Int. Cl. H04B 7/04; H04B 7/0456; H04B 7/06; H04W 8/22; H04W 64/00

(52) U.S. Cl. CPC H04B 7/04013; H04B 7/0456; H04B 7/0652; H04W 8/22; H04W 64/00

(57) ABSTRACT

A computer-based method of configuring a digitally controllable scatterer (DCS) for providing efficient and reliable focus between a node having a known location and a node having an unknown location with reduced delay. The method includes obtaining a structured codebook that includes a poset of codewords. Each codeword provides a focusing capability for a possible focusing point and defines a phase shift configuration for the plurality of scattering elements. The method includes selecting an initial codeword to provide focusing on a current focal point and transmits the signal to detect a focusing error. If the focusing error is below a preset error threshold value, then the current codeword is used by the DCS. If the focusing error is greater than the error threshold value, then a new focal point is selected to determine the focusing error until the focusing error is below the preset error threshold value with reduced complexity.

### CROSS-REFERENCE TO RELATED APPLICATIONS

This application is a continuation of International Application No. PCT/EP2022/079562, filed on Oct. 24, 2022, the disclosure of which is hereby incorporated by reference in its entirety.

### TECHNICAL FIELD

The present disclosure relates generally to the field of wireless communication systems and, more specifically, to a computer-based method for configuring a digitally controllable scatterer and a computer-based method for constructing a codeword or a codebook comprising a poset of codewords for defining phase shifts for the digitally controllable scatterer for providing focusing between nodes.

### BACKGROUND

Typically, a digitally controllable scatterer (DCS) is used for channel programming in wireless communication systems. The DCS may also be referred to as a large intelligent surface (LIS) or a reflective intelligent surface (RIS) that can change its scattering properties and radiation patterns by a computing corresponding phase shift configuration that specifies the phase shifts that are applied by the reflective elements in the DCS in order to serve a given region. Moreover, a huge number of reflective or scattering elements are required to be used at the DCS that further increases the complexity of computing the phase shifts for the DCS with respect to a required modification of the propagation channel.

Currently, certain attempts have been made in order to compute the phase shift configuration applied by the reflective elements in the DCS, such as by using a channel state information (CSI) that captures information of the propagation channel via the DCS. The other existing way to compute the phase shift configuration in the DCS is based on knowing an exact position of each communicating node, such as a transmitter, a receiver, and the DCS. However, such attempts are not desirable in a constantly changing environment, for example, due to a constant change in the position of a communicating node that further requires complex calculations to compute the phase shift for the configuration of the DCS. In certain scenarios, the phase shift configuration in the DCS can also be computed by using the determination of its spatial position and the CSI matrix, which results in large computational complexity, and thus not desirable. Moreover, there are certain attempts that are based on CSI acquisition, such as applying a matched filter (MF) in order to compute the phase shifts in the DCS. However, such attempts further require a large complex calculation that causes a delay in the processing of the large complex calculation. Thus, there exists a technical problem of how to compute the phase shift configuration in the DCS with reduced complexity and reduced processing delay.

Therefore, in light of the foregoing discussion, there exists a need to overcome the aforementioned drawbacks associated with conventional systems and methods related to computing phase shift configuration applied by the reflective elements in the DCS.

### SUMMARY

The present disclosure provides a computer-based method for configuring a digitally controllable scatterer and a computer-based method for constructing a codebook comprising a poset of codewords for defining the phase shifts for the digitally controllable scatterer. The present disclosure provides a solution to the existing problem of how to compute the phase shift configuration with reduced complexity and delay in processing. Alternatively stated, the problem is how to compute or identify the right codeword, i.e., the codeword that can provide focusing on an unknow target (e.g., a node) without channel state information (CSI) or position information. An aim of the present disclosure is to provide a solution that overcomes at least partially the problems encountered in the prior art and provides an improved computer-based method for configuring a digitally controllable scatterer and an improved computer-based method for constructing the codebook comprising the poset of codewords for defining the phase shifts for the digitally controllable scatterer to provide focusing between nodes with unknown position in space. This results in a solution performing a three-dimensional auto-focusing towards an unknown target for DCS configuration.

One or more objectives of the present disclosure are achieved by the solutions provided in the enclosed independent claims. Advantageous implementations of the present disclosure are further defined in the dependent claims.

In one aspect, the present disclosure provides a computer-based method of configuring a digitally controllable scatterer for providing focusing between a first communication node having a known location and a second communication node having an unknown location. One of the first and second communication nodes is a transmitter (Tx), and the other one is a receiver (Rx). The method includes the steps of obtaining a structured codebook, including a poset of codewords. Each codeword is designed to provide a focusing capability towards a possible focusing point in space. Each codeword defines a respective phase shift configuration for the plurality of scattering elements of the digitally controllable scatterer. The poset is ordered as a function of distance and direction between the possible focusing points. Further, selecting an initial codeword from the codebook to be used as a current codeword, said initial codeword being arranged to provide focusing towards a current focal point F_{c} and transmitting a signal from the transmitter and detecting a delay spread based on the received signal at the Rx. The method further includes determining a focusing error as a function of the detected delay spread and if the focusing error is below a preset error threshold value, then using the current codeword for configuring the digitally controllable scatterer and ending the method. If the focusing error is greater than the error threshold value, then selecting a new focal point Fₙ as F_{c} based on the estimated error and determining a new codeword from the codebook to provide focusing towards F_{c}. Further, the computer-based method repeats steps until the focusing error is below the preset error threshold value.

The computer-based method is used to configure the DCS to provide focus between the first communication node with the known location and the second communication node with the unknown location through the structured codebook and provides focusing capabilities of the plurality of scattering elements of the DCS based on the focusing error. In addition, the computer-based method is used to configure the DCS to serve the region more efficiently and reliably with reduced delay spread perceived at the receiver (achieve focusing) in a constantly changing environment. Additionally, the computer-based method is configured to provide a solution to compute the phase shifts efficiently and reliably with reduced complexity and delay in processing.

In an implementation form, the estimated error is a vector having a slope, a direction, and a magnitude.

The estimated error, which is a vector is used to select the new focal point Fₙ and also to determine a new codeword in order to configure the DCS with the codeword that provides focusing towards the new focal point Fₙ.

In a further implementation form, the new focal point Fₙ is selected based on the slope and direction of the vector.

The selection of the new focal point Fₙ is used to select the new codeword that is further used to configure the DCS with reduced focusing error.

In yet another aspect, the present disclosure provides a digitally controllable scatterer for use in a wireless communications network configured according to the method.

The digitally controllable scatterer for use in the wireless communication network achieves all the advantages and technical effects of the computer-based method of the present disclosure.

In another aspect, the present disclosure provides a node for use in a wireless communications network, comprising a program memory having stored thereon a computer program product so that it can perform the method. For example, a transmitter, a receiver or a digitally controllable scatterer.

The node, such as the transmitter, the receiver, and the DCS for use in the wireless communication network comprising program memory achieves all the advantages and technical effects of the computer-based method of the present disclosure.

In another aspect, the present disclosure provides a computer-based method of constructing a codebook comprising a poset of codewords for defining phase shifts for a digitally controllable scatterer, including for each of a number of sets of points Rx and Tx indicating possible positions for a receiver and a transmitter respectively. The method includes determining at least a first and a second codeword by obtaining a set [symbol] of points M. Each point M is a point representing a position of a scattering element of the digitally controllable scatterer. For each point, M in the set [symbol] , the method includes finding an ellipsoid ε* having Rx and Tx as foci points, selecting a point M on the digitally controllable scatterer, constructing an ellipse E as the intersection of the plane TxMRx with the ellipsoid, computing a distance from the transmitter to the receiver through the point M via a path intersecting the ellipse E in a point V between the point M and the receiver, and computing a distance from the transmitter to the receiver through the point V. Further, the method includes determining a phase compensation for the scatterer at point M based on the determined phase shift so that a signal along the path TxMRx will present the same phase when reaching Rx as a signal along the path TxVRx. Further, determining a codeword based on the phase shifts for all points M in the set [symbol] and including the codeword in the codebook.

The computer-based method for constructing the codebook provides an efficient and reliable solution for calculating the phase shift configuration for the DCS. Thus, determining a phase compensation for the scatterer ensures that the signal is transmitted along the path with the same phase. Thus, the computer-based method is used to provide the data transmission between the transmitter and the receiver more efficiently and reliably.

It is to be appreciated that all the aforementioned implementation forms can be combined. It is be noted that all devices, elements, circuitry, units, and means described in the present application could be implemented in the software or hardware elements or any kind of combination thereof. A II steps which are performed by the various entities described in the present application, as well as the functionalities described to be performed by the various entities, are intended to mean that the respective entity is adapted to or configured to perform the respective steps and functionalities. Even if, in the following description of specific embodiments, a specific functionality or step to be performed by external entities is not reflected in the description of a specific detailed element of that entity that performs that specific step or functionality, it should be clear for a skilled person that these methods and functionalities can be implemented in respective software or hardware elements, or any kind of combination thereof. It will be appreciated that features of the present disclosure are susceptible to being combined in various combinations without departing from the scope of the present disclosure as defined by the appended claims.

Additional aspects, advantages, features, and objects of the present disclosure would be made apparent from the drawings and the detailed description of the illustrative implementations construed in conjunction with the appended claims that follow.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following diagrams wherein:

FIG. 1A is a network environment diagram of a wireless communication system, in accordance with an embodiment of the present disclosure;

FIGS. 1B, 1C, and 1D are different block diagrams that depict a node, a digitally controllable scatterer (DCS), and a node, in accordance with an embodiment of the present disclosure;

FIG. 2 is a flowchart of a computer-based method for configuring a digitally controllable scatterer, in accordance with an embodiment of the present disclosure;

FIG. 3 is a flowchart of a computer-based method for constructing a codebook, in accordance with an embodiment of the present disclosure;

FIG. 4 is a diagram that depicts a digitally controllable scatterer (DCS) and computation of a phase shift for scattering elements of the DCS, in accordance with an embodiment of the present disclosure;

FIG. 5A is a diagram that depicts the construction of a codebook, in accordance with an embodiment of the present disclosure;

FIG. 5B is a diagram that depicts a selection of codeword within a codebook, in accordance with an embodiment of the present disclosure;

FIG. 6 is a diagram that depicts an exemplary computation of a focusing error matrix, in accordance with an embodiment of the present disclosure;

FIG. 7 is a flowchart that depicts different operations for selecting a codeword for data transmission, in accordance with an embodiment of the present disclosure;

FIG. 8 is a diagram that depicts an ellipsoid selection for codeword computation, in accordance with an embodiment of the present disclosure;

FIG. 9 is a diagram that depicts an exemplary representation of an ellipsoid, in accordance with an embodiment of the present disclosure;

FIG. 10 is a three-dimensional (3D) graphical representation that depicts an equivalent point of an ellipsoid emulated by a digitally controllable scatterer (DCS) based on a computed phase shift matrix, in accordance with an embodiment of the present disclosure;

FIG. 11 is a diagram that depicts an exemplary focusing process for a digitally controllable scatterer (DCS), in accordance with an embodiment of the present disclosure;

FIG. 12 is a flowchart that depicts different operations for the exchange of messages between a digitally controllable scatterer (DCS) and two nodes, in accordance with an embodiment of the present disclosure;

FIG. 13 is a flowchart that depicts different operations during the exchange of messages between a digitally controllable scatterer (DCS) and two nodes, in accordance with an embodiment of the present disclosure;

FIG. 14A is a flowchart that depicts different operations of processing at a node, in accordance with an embodiment of the present disclosure;

FIG. 14B is a flowchart that depicts different operations for the exchange of messages between a digitally controllable scatterer (DCS) and two nodes, in accordance with an embodiment of the present disclosure; and

FIGS. 15A to 15E are different diagrams that depicts exemplary configurations of scattering surfaces of a DCS, in accordance with different embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

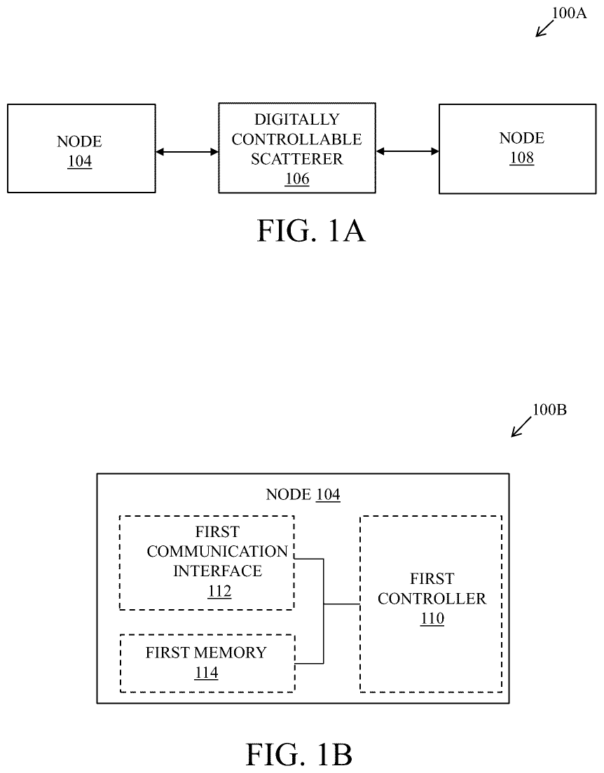

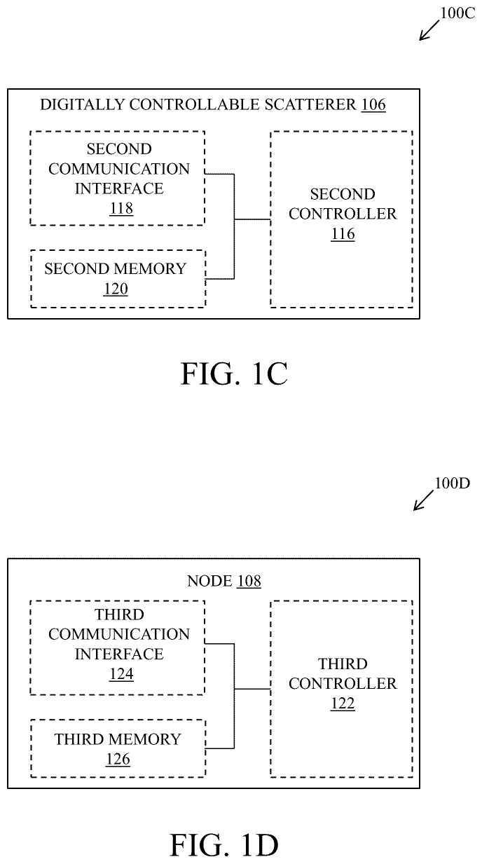

FIG. 1A is a network diagram of a wireless communication system, in accordance with an embodiment of the present disclosure. With reference to FIG. 1A, there is shown the network diagram of a wireless communication system 100A that includes a wireless communication network, a node 104, a digitally controllable scatterer (DCS) 106, and a node 108

The DCS 106 is configured to provide focus between the node 104 and the node 108 In an implementation, the node 104 corresponds to a transmitter and the node 108 corresponds to a receiver. In another implementation, the node 104 corresponds to the receiver and the node 108 corresponds to the transmitter. Examples of the node 104 and the node 108 may include, but are not limited to, a transmitter, a sender, a transceiver, an encoder, a user terminal of a cellular network, a customized hardware for wireless telecommunication, or any other portable or non-portable electronic device, a receiver, a decoder, a transceiver, a base station or an access point in a cellular network, and the like.

Examples of the wireless communication network (or propagation environment, wireless propagation environment) may include, but are not limited to, a cellular network, a wireless sensor network (WSN), a cloud network, a Local Area Network (LAN), a vehicle-to-network (V2N) network, a Metropolitan Area Network (MAN), and the like.

In operation, the DCS 106 is configured to provide focus between the node 104, which includes a known location, and the node 108, which includes an unknown location. In an implementation, the node 104 corresponds to a transmitter (Tₓ) and the node 108 corresponds to a receiver (Rₓ). The DCS 106 obtains a structured codebook that includes a poset of codewords. Moreover, each codeword is designed to provide a focusing capability towards a possible focusing point in space, and each codeword defines a respective phase shift configuration for the plurality of scattering elements of the DCS 106 The poset is ordered as a function of distance and direction between the possible focusing points. Furthermore, the DCS 106, or any other entity from the network like node 104 or node 108 is configured to select an initial codeword from the codebook (i.e., the structured codebook). The selected initial codeword is arranged to provide focus toward a current focal point (F_{c}). Thereafter, the node 104 is configured to transmit a signal and a delay spread based on the received signal is detected at the node 108 (i.e., the receiver, Rx). Furthermore, the DCS 106, or any other entity from the network like node 104 or node 108 is configured to determine a focusing error as a function of the detected delay spread, and if the focusing error is below a predefined error threshold value, then the current codeword is used for configuring the DCS 106 However, if the focusing error is greater than the error threshold value, then the DCS 106 is used to select a new focal point Fₙ as F_{c}, based on the estimated error and determine a new codeword from the codebook to provide focus towards F_{c} and again transmits the signal to determine the delay and further calculates the focusing error till the focusing error is below the predefined error threshold value. This enables the efficient and accurate selection of the codebook to configure the DCS 106 for providing a focus between the node 104 and the node 108 However, it is to be understood that any other entity (e.g., a communication node) executing the autofocusing process may be used to select new foci point Fₙ as F_{c}, and that the autofocusing capability may not be exclusively located at the DCS alone. In an example, the focusing error can be determined at any other entity (e.g., communication node).

FIGS. 1B, 1C, and 1D are different block diagrams that depict a node, a digitally controllable scatterer (DCS), and a node, in accordance with different embodiments of the present disclosure. With reference to FIG. 1B there is shown a block diagram 100B of the node 104 that includes a first communication interface 112 a first memory 114, and a first controller 110 With reference to FIG. 1C, there is shown a block diagram 100C of the DCS 106 that includes a second controller 116, a second communication interface 118, and a second memory 120 Furthermore, with reference to FIG. 1D, there is shown a block diagram 100D of the node 108 that includes a third controller 122 a third communication interface 124, and a third memory 126

The first communication interface 112 is used by the node 104 to communicate with the node 108 and the DCS 106 Moreover, the second communication interface 118 is used by the DCS 106 to communicate with the node 104 and the node 108 Furthermore, the third communication interface 124 is used by the node 108 to communicate with the node 104 and the DCS 106 Examples of implementation of the first communication interface 112 the second communication interface 118, and the third communication interface 124 may include but are not limited to a network interface, a computer port, a network socket, a network interface controller (NIC), and any other network interface device.

Examples of implementation of the first controller 110, the second controller 116, and the third controller 122 may include but are not limited to a central data processing device, a microprocessor, a microcontroller, a complex instruction set computing (CISC) processor, an application-specific integrated circuit (ASIC) processor, a reduced instruction set (RISC) processor, a very long instruction word (VLIW) processor, a state machine, and other processors or control circuitry.

Examples of implementation of the first memory 114, the second memory 120, and the third memory 126 may include, but are not limited to, Electrically Erasable Programmable Read-Only Memory (EEPROM), Dynamic Random-Access Memory (DRAM), Random Access Memory (RAM), Read-Only Memory (ROM), Hard Disk Drive (HDD), Flash memory, a Secure Digital (SD) card, Solid-State Drive (SSD), and/or CPU cache memory.

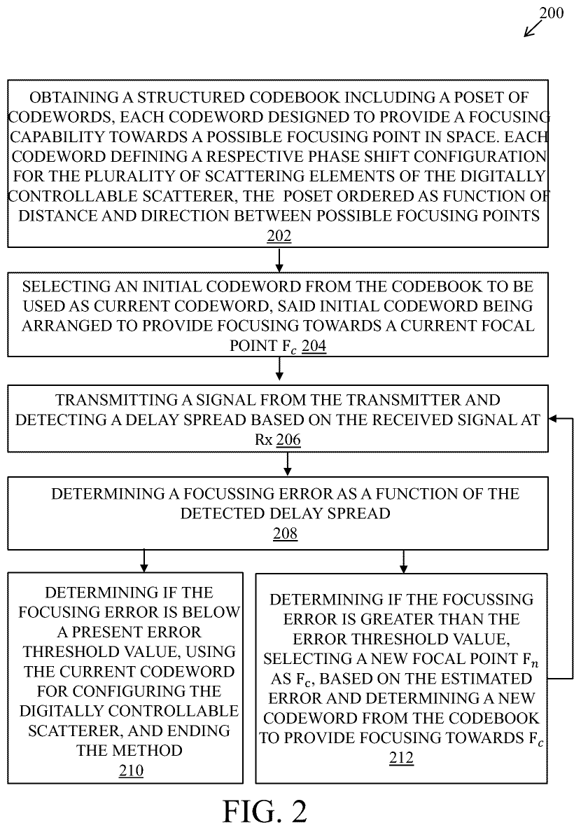

One of the network entities, such as the node 104 or the node 108 or the DCS 106, is configured provide focusing error between a first communication node with a known location and a second communication node with an unknown location, one of the first and second communication nodes being a transmitter Tx and the other one a receiver Rx, as further shown and described in FIG. 2. Examples of the node 104 may include, but are not limited to, a transmitter, and a receiver. The node 104 includes a program memory having stored thereon. The computer program product can perform the computer-based method. Examples of implementation of program memory include, but are not limited to, Electrically Erasable Programmable Read-Only Memory (EEPROM), Random Access Memory (RAM), Read Only Memory (ROM), Hard Disk Drive (HDD), Flash memory, a Secure Digital (SD) card, Solid-State Drive (SSD), a computer-readable storage medium, and/or CPU cache memory.

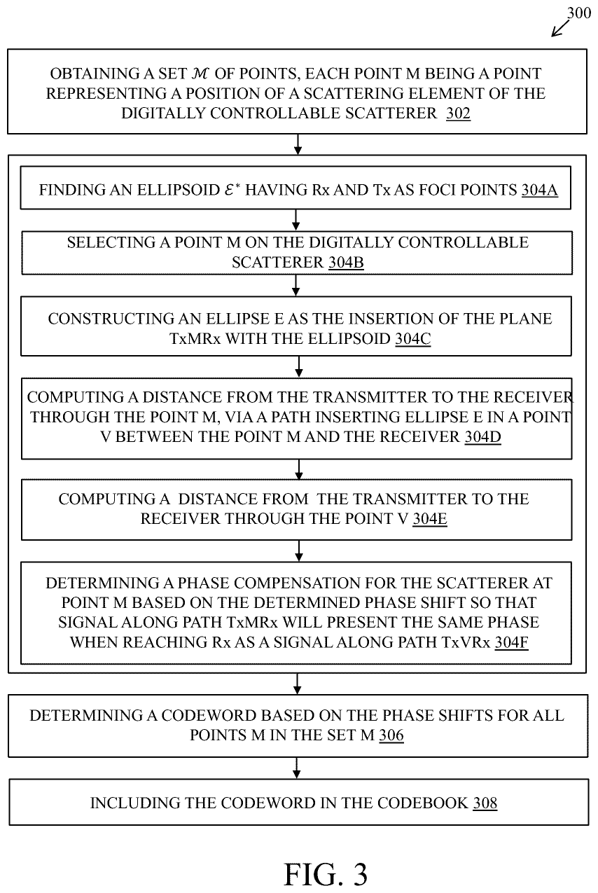

Furthermore, in an exemplary implementation, one of the network entities, such as the node 104 or the node 108 or the DCS 106 is used for constructing a poset of codewords for defining phase shifts for the DCS 106, including for each of a number of sets of points Rx and Tx indicating possible positions for a receiver and a transmitter respectively, as further shown and described in FIG. 3. Examples of the node 108 may include, but are not limited to, a transmitter, and a receiver. The node 108 includes a program memory having stored thereon. The computer program product can perform the computer-based method. Examples of implementation of program memory include, but are not limited to, Electrically Erasable Programmable Read-Only Memory (EEPROM), Random Access Memory (RAM), Read Only Memory (ROM), Hard Disk Drive (HDD), Flash memory, a Secure Digital (SD) card, Solid-State Drive (SSD), a computer-readable storage medium, and/or CPU cache memory.

There is further provided the DCS 106 configured for providing a focusing between the first communication node with a known location and the second communication node with an unknown location, as further shown and described in FIG. 2. Moreover, one of the first and second communication nodes being a transmitter Tx and the other one a receiver Rx. The DCS 106 is configured to obtain the structured codebook, including the poset of codewords, and each codeword is designed to provide the focusing capability towards the possible focusing point in space. Further, each codeword defines the respective phase shifts configuration for the plurality of scattering elements of the DCS 106 The DCS 106 is further configured to select the initial codeword from the codebook to be used as a current codeword and can request to transmit the signal from the transmitter. Further, the receiver Rx detects the delay spread based on the received signal at the receiver Rx and determines the focusing error as the function of the detected delay spread. If the focusing error is below a preset error threshold value, then use the current codeword to configure the DCS 106 If the focusing error is greater than the error threshold value, then select the new focal point Fₙ as F_{c} based on the estimated error and determining a new codeword from the codebook to provide focus towards F_{c}. Thus, the DCS 106 is used to provide focusing between the nodes (i.e., between the node 104 and the node 108) to provide efficient transmission of signals.

FIG. 2 is a flowchart of a computer-based method for configuring a digitally controllable scatterer, in accordance with an embodiment of the present disclosure. FIG. 2 is described in conjunction with elements from FIGS. 1A, 1B, 1C, and FIG. 1D. With reference to FIG. 2, there is shown a flowchart of a computer-based method 200 that includes steps 202 to 212 The DCS 106 is configured to execute the computer-based method 200 (herein may also be referred to as a method 200).

The computer-based method 200 comprises configuring the DCS 106 for providing focusing between a first communication node with a known location and a second communication node with an unknown location. Moreover, one of the first communication node (e.g., the node 104) and the second communication node (e.g., the node 108) is a transmitter (Tₓ) and the other one is a receiver (Rₓ). In an implementation, the first communication node (e.g., the node 104) is the transmitter (Tx) and the second communication node (e.g., the node 108) is the receiver (Rx). In another implementation, the first communication node (e.g., the node 104) is the receiver (Rx) and the second communication node (e.g., the node 108) is the transmitter (Tx). In addition, the DCS 106 is used to provide focus between the first communication node and the second communication node. In an implementation, one or more tools and approaches can be considered in the construction of the codewords and the poset codebook, among them. For instance, geometrical based approaches, selection from larger random codebooks, machine learning based construction with online and/or offline learning approaches, raytracing-based approximation, and simulations, and/or electromagnetic (EM) field simulations with optimization processes. In an implementation, a codebook is provided as an input.

At step 202 the computer-based method 200 comprises obtaining a structured codebook that includes a poset of codewords. In other words, the structured codebook is provided as an input. In an implementation, the structured codebook is generated for encoding phase shifts of the DCS 106, such as by obtaining a set [symbol] of points M, where each point M is a point representing a position of a scattering element of the DCS 106 In addition, for each point M in the set [symbol] , the method 200 includes, determining the structured codeword based on the phase shifts for all the points M in the set [symbol] , such as the poset of the codeword is included in the structured codebook. In an example, a closed form expression is used to generate the poset of the codewords based on the structured codebook, such as the closed-form expression includes a function of the coordinates of the transmitter (e.g., the node 104), the receiver (e.g., the node 108), the points M, and the DCS 106 Moreover, each codeword from the poset of the codewords is designed to provide a focusing capability towards a possible focusing point in space. In an implementation, the poset of the codewords in the structured codebook constitutes an ordered set of the codewords with respect to a focusing metric that is related to a spatial positioning of the possible focusing (i.e., foci) point in the space. In an example, the poset of the codewords is ordered as a function of distance and direction between two possible focusing points in the space, such as between the first communication node and the second communication node. The possible focusing point is used by the DCS 106 to further scatter the impinging signal arriving from the first communication node to the second communication node, which includes an unknown location. Furthermore, each codeword from the poset of the codewords defines a respective phase shift configuration for the plurality of scattering elements of the DCS 106 The defined respective phase shift configuration is used by the DCS 106 to configure the phases of the reflective or scattering elements of the DCS and scatter the signal in a way that provides focusing towards the desired destination (e.g., the node 108). In an implementation, at step 202, the codebook is obtained as the input to the algorithm and hence the step 202 does not perform codebook generation but instead simply obtains the codebook as the input.

Furthermore, at step 204, the computer-based method 200 comprises selecting an initial codeword from the structured codebook to be used as a current codeword. The initial codeword is arranged to provide focusing on a current focal point F_{c} in space. The selected initial codeword from the structured codebook provides the focusing towards the current focal point F_{c} that is used by the DCS 106 for determining the location of the second communication node (e.g., the receiver, Rx). In other words, finding the optimal focal point provides the location of the second communication node (e.g., the receiver, Rx) as they are correlated through the Poset of codewords.

At step 206, the computer-based method 200 comprises transmitting the signal from the transmitter and estimating a delay spread based on the received signal at the receiver (Rₓ) In an implementation, the signal is transmitted from the first communication node (e.g., the node 104), and the computer-based method 200 comprises, detecting (e.g., by the receiver (Rₓ)) the delay spread, based on the received signal at the second communication node (e.g., the node 108). In another implementation, the signal is transmitted from the second communication node (e.g., the node 108), and the computer-based method 200 comprises, detecting (e.g., by the receiver (Rₓ)) the delay spread based on the received signal at the first communication node (e.g., the node 104). Moreover, the transmitter (e.g., the node 104 or the node 108) is configured to transmit the signal through the DCS 106 being configured with the selected initial codeword from the structured codebook that focuses on a point, such as a point F that is different from the position of the receiver (e.g., the node 108 or the node 104) due to which the signal arriving with different delays at the receiver experiences multiple delay and delay spread. In an implementation, the receiver perceives multiple delayed versions of the signal that is transmitted from the transmitter. Moreover, the difference between the perceived delay is represented in the form of a time difference between a first perceived tap (i.e., signal arriving from a first channel path) and a last perceived tap (i.e., signal arriving from a last channel path) that is further denoted as the delay spread.

Furthermore, at step 208, the computer-based method 200 comprises determining a focusing error (i.e., \vec{FRx}) as a function of the detected delay spread. In an implementation, the computer-based method 200 includes, computing delay spread toward the unknown location of the receiver (e.g., the node 108) for the received signal, such as the delay spread based on the received signal that includes the focusing error (i.e., \vec{FRx}). In an example, the focusing error is expressed as a function of the delay spread (e.g., measured delay spread) and also the function of all the fixed components, such as the transmitter (with known location), the DCS 106, and more specifically on two extreme points of the DCS 106, which is further shown and described in detail in FIG. 6. The determination of the focusing error (i.e., \vec{FRx}) is used for selecting a correct codeword that is further used for configuring the DCS 106 for providing focus between the transmitter (e.g., node 104) and the receiver (e.g., the node 108).

At step 210, the computer-based method 200 comprises, determining if the focusing error is below a predefined error threshold value, then the computer-based method 200 comprises configuring the DCS 106 for providing focusing between the transmitter and the receiver. The focusing error that is less than the predefined threshold value states that the signal is transmitted successfully from the transmitter (e.g., the node 104) to the receiver (e.g., the node 108) efficiently after the configuration of the focusing properties of the DCS 106

At step 212 the computer-based method 200 comprises, determining, if the focusing error (i.e., \vec{FRx}) is greater than the error threshold value, then the computer-based method 200 comprises, selecting a new focal point (Fₙ) as (F_{c}), based on the estimated error and determining a new codeword from the structured codebook to provide focusing towards the current focal point (F_{c}). The new focal point (Fₙ) is selected to reduce the value of the focusing error below the error threshold value so that the transmission of the signal from the transmitter (e.g., the node 104) to the receiver (e.g., the node 108) is more efficient. Moreover, the new codewords from the codebook are determined till the focusing error is below the predefined error threshold value. For example, after the selection of a first codeword, if the focusing error is greater than the error threshold value, then, a second codeword is selected, and again the focusing error is computed till the focusing error is below the error threshold value. In accordance with an embodiment, the estimated error is a vector that includes a slope, a direction, and a magnitude. Moreover, the computer-based method 200 comprises using the vector for selecting the new focal point (Fₙ) and for determining the new codeword in order to configure the DCS 106 with the codeword that provides a reduced focusing error. In accordance with an embodiment, the new focal point (Fₙ) is selected based on the slope and direction of the vector. The selection of the new focal point (Fₙ) is used for selecting the new codeword that is used for configuring the DCS 106 with reduced focusing error. In accordance with an embodiment, the new focal point (Fₙ) is further selected by setting the magnitude (i.e., step size) based on an iterative optimization algorithm. The iterative optimization algorithm is used for selecting the new focal point (Fₙ) that is further used for computing the desired codeword within the codebook that is closest for providing convergence.

The computer-based method 200 is used to configure the DCS 106 to provide focus between the node 104 (e.g., the first communication node) with the known location and the node 108 (e.g., the second communication node) with the unknown location through the structured codebook and provides focusing capabilities of the plurality of scattering elements of the DCS 106 based on the focusing error. In addition, the computer-based method 200 is used to configure the DCS 106 to serve the region more efficiently and reliably with reduced delay spread perceived at the receiver (achieve focusing) in a constantly changing environment. Additionally, the computer-based method 200 is configured to provide a solution to compute the phase shift configuration efficiently and reliably with reduced complexity and delay in processing. The steps 202 to 212 are only illustrative, and other alternatives can also be provided where one or more steps are added, one or more steps are removed, or one or more steps are provided in a different sequence without departing from the scope of the claims herein.

There is further provided, a computer program product comprising a non-transitory storage medium having computer-readable codes means are stored. In such an embodiment, the computer program product comprising computer-readable code which, when run in a node 104 in the wireless communication network including the DCS 106 causes the node 104 to perform the computer-based method 200 The computer program product is implemented as an algorithm, embedded in a software stored in the non-transitory computer-readable storage medium. The non-transitory computer-readable storage means may include but are not limited to, an electronic storage device, a magnetic storage device, an optical storage device, an electromagnetic storage device, a semiconductor storage device, or any suitable combination of the foregoing. Examples of implementation of computer-readable storage medium, but are not limited to, Electrically Erasable Programmable Read-Only Memory (EEPROM), Random Access Memory (RAM), Read Only Memory (ROM), Hard Disk Drive (HDD), Flash memory, a Secure Digital (SD) card, Solid-State Drive (SSD), a computer-readable storage medium, and/or CPU cache memory.

FIG. 3 is a flowchart of a computer-based method for constructing a codebook, in accordance with an embodiment of the present disclosure. FIG. 3 is described in conjunction with elements from FIGS. 1A, 1B, 1C, and 1D. With reference to FIG. 3, there is shown a flowchart of a computer-based method 300 that includes steps 302 to 308 The DCS 106 (or a network entity, such as the node 104) may be configured to execute the computer-based method 300 (herein may also be referred to as a method 300).

There is provided the computer-based method 300 of constructing a codebook that includes a poset of codewords for defining phase shifts for the DCS 106 (of FIG. 1A). The phase shifts for the DCS 106 are defined for each of a number of sets of points such as the Rₓ and Tₓ that indicates the possible positions for the receiver and the transmitter respectively. In an implementation, the number of sets of points such as the Rₓ and the Tₓ indicates the possible positions for the second communication node (e.g., the node 108) and the first communication node (e.g., the node 104) respectively. In another implementation, the number of sets of points such as the Rx and the Tx indicates the possible positions for the first communication node (e.g., the node 104) and the second communication node (e.g., the node 108) respectively.

At step 302 the computer-based method 300 comprises obtaining a set M of points M, each point M being a point representing a position of a scattering element of the digitally controllable scatterer. The method 300 further include, determining at least a first and a second codeword. Each point M is a point that represents a position of a scattering element of the DCS 106 For example, the computer-based method 300 obtains the set [symbol] of M points where a point corresponds to the center of a scattering element of the DCS 106 After obtaining the set of M points, the computer-based method 300 comprises a plurality of steps from step 304A to step 304F for determining the codeword based on the phase shift for each point M from the set [symbol] .

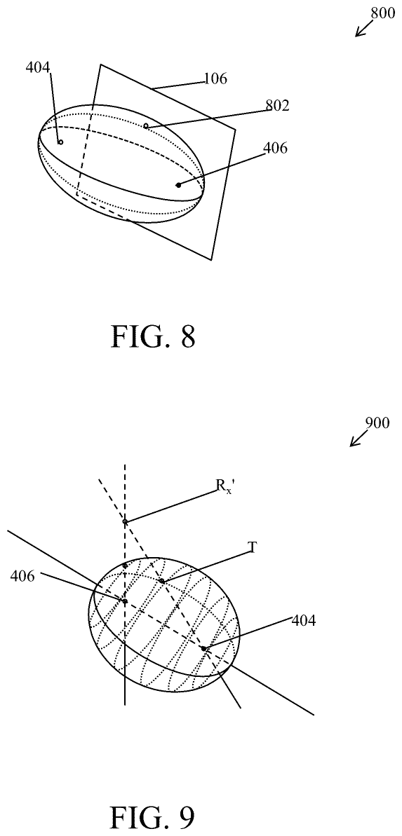

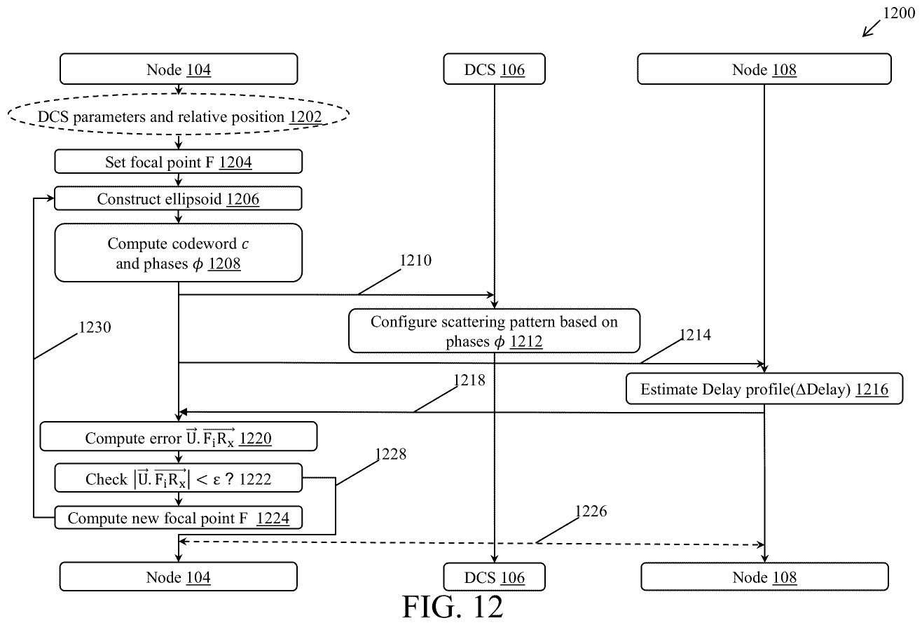

At step 304A, the computer-based method 300 comprises, for each point M in the set [symbol] finding an ellipsoid ε* that has Rₓ and Tₓ as foci points. The ellipsoid ε* is selected as tangent to the DCS 106 that is used to simplify the calculation required to compute the phase shift for the scattering element. The focal point Tₓ corresponds to the point that indicates the possible position of the transmitter (e.g., the node 104). Similarly, the Rₓ corresponds to the point that indicates the possible position for the receiver (e.g., the node 108). In an example, for a transmitting point F₁, assimilated to a transmitter Tₓ, a receiving point F₂ representing a receiver Rx and a plane [symbol] representing the reflecting surface DCS, there is a unique ellipsoid ε* that is tangent to the plane [symbol] . Furthermore, at step 304B, the computer-based method 300 comprises selecting the point M on the DCS 106 Moreover, the point M represents the position of the scattering element of the DCS 106 for defining the phase shift of the DCS 106. Furthermore, at step 304C, the computer-based method 300 comprises constructing an ellipse E as the intersection of the plane TₓM Rₓ with the ellipsoid ε*. The ellipsoid ε* is further described in detail in FIG. 8 and FIG. 9. In accordance with an embodiment, the ellipsoid ε* is constructed by constructing a symmetric point F′_{c} of a current focal point F_{c} with respect to the plane of the DCS 106 The ellipsoid ε* is constructed by constructing a point T at the intersection of the line F′_{c}Tₓ with the plane of the digitally controllable scatterer and constructing the ellipse with foci points F_{c}, and passing through the point T (tangent point) (e.g., as shown in FIG. 9) Moreover, the ellipsoid ε* is constructed by rotating the ellipse around its main axis F_{c} Tx. The construction of the ellipsoid ε* is described in detail in FIG. 12 and is used to configure DCS 106 by constructing the codebook for providing the focusing between the first communication node (e.g., the node 104) and the second communication node (e.g., the node 108).

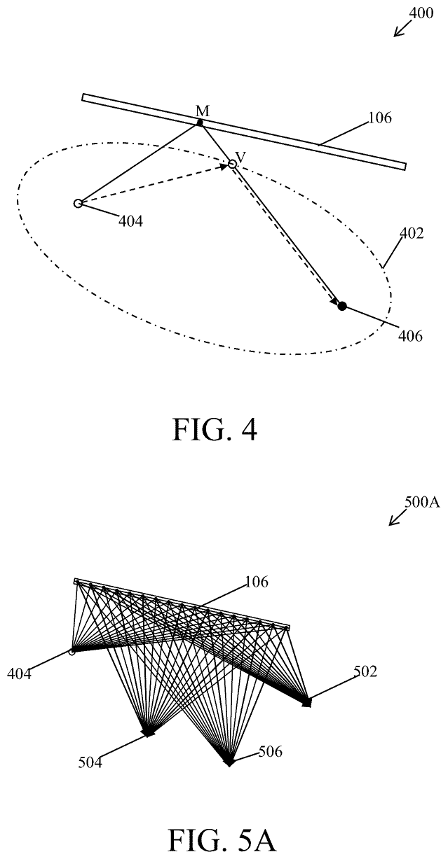

At step 304D, the computer-based method 300 comprises computing a distance from the transmitter to the receiver through the point M via a path intersecting the ellipse E in a point V between the point M and the receiver. In other words, the path originates from the transmitter (e.g., the node 104) to the receiver (e.g., the node 108) through the surface (e.g., MRₓ) of the DCS 106 and through the path intersects the ellipse E in the point V between the point M and the receiver (e.g., the node 108). The DCS 106 further mimics a reflecting behavior of the ellipsoid and acquires the focusing properties to ensure that both paths, such as the plane TₓVRₓ and TₓMRₓ are present in the same phase, as further described in FIG. 4. Furthermore, at step 304E, the computer-based method 300 comprises computing a distance from the transmitter to the receiver through the point V. The computation of the distance from the transmitter (e.g., the node 104) is further described in detail in FIG. 4. At step 304F, the computer-based method 300 comprises determining a phase compensation for the scatterer at point M based on the determined phase shift so that a signal along the path in the plane TₓMRₓ will present the same phase when reaching the Rₓ as a signal along the path in the plane TₓV Rₓ. The phase shift is used for providing the focusing between the transmitter (e.g., the node 104 and the receiver (e.g., the node 108). Thereafter, at step 306, the computer-based method 300 comprises determining a codeword based on the phase shifts for all points M in the set [symbol] , and at step 308, the method 300 comprises including the codeword in the codebook.

The computer-based method 300 is used for constructing the codebook and provides an efficient and reliable solution to calculate the phase shift configuration for the DCS 106 The computer-based method 300 includes determining at least a first and a second codeword by obtaining a set of points to construct the ellipsoid by computing the distance between the transmitter and the receiver. Thus, determining a phase compensation for the scatterer ensures that the signal is transmitted along the path with the same phase. Thus, the computer-based method 300 is used to provide the data transmission between the transmitter (e.g., the node 104) and the receiver (i.e., the node 108) more efficiently and reliably.

The steps 302 to 308 (along with the steps 304A to 304F) are only illustrative, and other alternatives can also be provided where one or more steps are added, one or more steps are removed, or one or more steps are provided in a different sequence without departing from the scope of the claims herein.

There is provided, a computer program product comprising a non-transitory storage medium having computer-readable codes means are stored. In such an embodiment, the computer program product comprising computer-readable code, which, when run in the node 108 in the wireless communication network including the DCS 106 causes the node 108 to perform the computer-based method 300 The computer program product is implemented as an algorithm, embedded in a software stored in the non-transitory computer-readable storage medium. The non-transitory computer-readable storage means may include but are not limited to, an electronic storage device, a magnetic storage device, an optical storage device, an electromagnetic storage device, a semiconductor storage device, or any suitable combination of the foregoing. Examples of implementation of computer-readable storage medium, but are not limited to, Electrically Erasable Programmable Read-Only Memory (EEPROM), Random Access Memory (RAM), Read Only Memory (ROM), Hard Disk Drive (HDD), Flash memory, a Secure Digital (SD) card, Solid-State Drive (SSD), a computer-readable storage medium, and/or CPU cache memory.

FIG. 4 is a diagram that depicts a digitally controllable scatterer (DCS) and computation of a phase shift for scattering elements of the DCS, in accordance with an embodiment of the present disclosure. FIG. 4 is shown in conjunction with elements from FIGS. 1A, 1B, 1C, and 1D. With reference to FIG. 4, there is shown a diagram 400 that depicts the computation of the phase shift configuration for the scattering elements of the digitally controllable scatterer (DCS) 106 (of FIG. 1A).

There is shown an ellipsoid ε* that is constructed to compute the phase shift configuration for the scattering elements of the DCS 106 In an implementation, a point M is shown on the DCS 106 that is located in the center of the scattering elements of the DCS 106 Furthermore, the ellipse E is constructed as the intersection of the plane (TₓMRₓ) with the ellipsoid ε* that is represented in dotted line 402 in FIG. 4. Thereafter, a ray originated from the transmitter 404 (e.g., the node 104) to the receiver 406 (e.g., the node 108), while bouncing on the point M on the DCS 106 is computed, the ray represents a path along which a signal would propagate. The ray is reflected from the DCS 106, which is represented as MRx, (i.e., on the point M), and intersects the ellipse E in a point V. In an implementation, the reflection is performed by the DCS 106 that acquire the behavior or the performance of the ellipsoid shape reflector through a specific codeword, so the reflection is not via the ellipsoid but still via the DCS 106 that emulates the properties of the ellipsoid due to the phase shift configuration (i.e., the codeword). Moreover, to ensure the reflecting behavior of the DCS 106 emulating reflection from the ellipsoid and acquire the focusing properties, both the paths TₓVRₓ and TₓMRₓ should have the same phase configuration. Therefore, in order to achieve the same phase configuration, the phase at point M of the DCS 106 is required to be compensated by the following path difference, as shown below in equation (1):

$${ϕ}_{M} = \frac{2 {πδ}_{m}}{λ} ≡ \frac{2 π}{λ} ( ‖ \vec{TxM} ‖ + ‖ \vec{MRx} ‖ - ‖ \vec{TxV} ‖ - ‖ \vec{VRx} ‖ ) [ 2 π ] \qquad ( 1 )$$

The phase compensation ϕ_{M} is geometrically constructed and can be computed as closed-form expressions as a function of the coordinates of the transmitter (e.g., the node 104), the receiver (e.g., the node 108), and the point M on the DCS 106 The resulting phase per scattering element is computed by the computation of the phase compensation ϕ_{M} for all the points M that corresponds to the center of the scattering elements of the DCS 106 that further provides a resulting phase for each scattering element of the DCS 106 Therefore, the DCS 106 obtains the codeword that is defined as the set of phases that provides a codeword as further shown below in equation (2).

$$c ( Tx , Rx , DCS ) = \{ {ϕ}_{M} , M ∈ DCS \} \qquad ( 2 )$$

Finally, the codebook aggregates all the codewords for given positions of the transmitter (e.g., the node 104) and the receiver (e.g., the node 108) in the specific region.

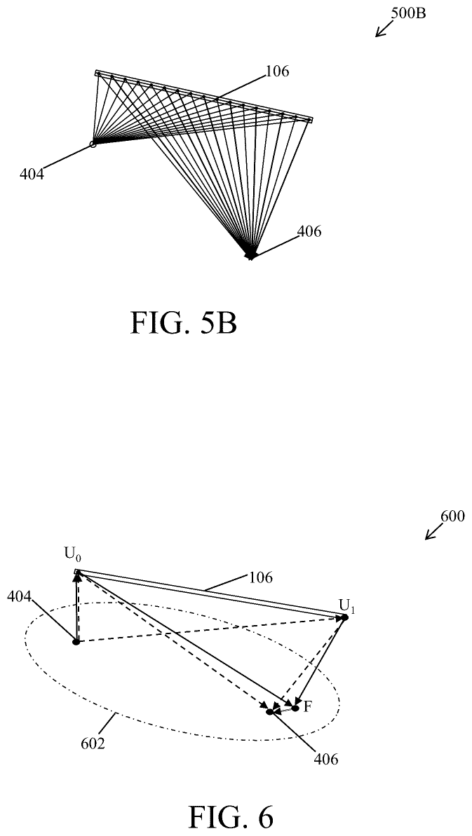

FIG. 5A is a diagram that depicts construction of a codebook, in accordance with an embodiment of the present disclosure. FIG. 5A is shown in conjunction with elements from FIGS. 1A, 1B, 1C, 1D, and 4. With reference to FIG. 5A, there is shown a diagram 500A that depicts the construction of the codebook for the configuration of the digitally controllable scatterer (DCS) 106 (of FIG. 1A).

The DCS 106 is configured to provide the focusing between the transmitter (e.g., the node 104) and the receiver (e.g., the node 108). The codebook includes the number of codewords that are designed to cover a specific region. However, the specific region may correspond to a region towards which the energy is focused. Firstly, the phase shift configuration matrix coding for all the elements on the DCS 106 constitutes the codeword for the specific region. Thereafter, the number of codewords is defined dynamically to focus on the existing regions on the DCS 106 to cover the specific region with a uniform or non-uniform grid. Moreover, the overall set of the codewords provides the codebook (C={cᵢ}). The set of codewords includes a first codeword providing focusing from a transmitter 404 towards a first focusing region 502 a second codeword for providing focusing from a transmitter 404 towards a second focusing region 504, and an n-th codeword for providing focusing from a transmitter 404 towards an n-th focusing region 506 that provides the convergence for the corresponding specific regions. For example, the second focusing codeword (or cᵢ) provides the coverage for the specific region 504 (i.e., i). Hence, the construction of the codebook provides a simple solution for computing a discretized (or infinite number) of phase profiles for the DCS 106 assisted communication setting through a mathematical construction of well-structured codebooks. In addition, the codewords are ordered with respect to a spatial distance differential vector to serve the specific region in a better way and provide a more easy and better DCS 106 configuration.

FIG. 5B is a diagram that depicts selection of a codeword within a codebook, in accordance with an embodiment of the present disclosure. FIG. 5B is shown in conjunction with elements from FIGS. 1A, 1B, 1C, 1D, 4, and 5A. With reference to FIG. 5B, there is shown a diagram 500B that depicts the selection of the codeword within the codebook in order to serve the specific region (i.e., the receiver 406) with an unknown location and without any channel state information (CSI). The computer-based method 300, as described in FIG. 3 provides a systematic solution for selecting the proper codeword in the codebook without any critical information on the positions of the various components, such as the transmitter 404, the DCS 106, and the receiver 406

FIG. 6 is a diagram that depicts an exemplary computation of a focusing error matrix, in accordance with an embodiment of the present disclosure. FIG. 6 is shown in conjunction with elements from FIGS. 1A, 1B, 1C, 1D, 4, 5A, and 5B. With reference to FIG. 6, there is shown a diagram 600 that depicts the exemplary computation of the focusing error matrix.

The diagram 600 shows the DCS 106, a transmitter 404 (e.g., the node 104 of FIG. 1A), and a receiver 406 (e.g., the node 108 of FIG. 1A) with an unknown location. In an implementation, the surface of the DCS 106 is a plane surface. Furthermore, two distinct points U₀ and U₁ are located on the surface of the DCS 106 Thereafter, the DCS 106 is configured for obtaining a codeword that provides a focusing capability on a point F in space. As the selected codeword is selected to focus on the point F that is different from the position of the receiver (e.g., the node 108), then it shows that the point at which the receiver is located perceives a delay spread version of the transmitted signal due to the propagation channel. Hence, the receiver (e.g., the node 108), perceives multiple versions of the signal arriving with different delays. Thus, the difference in perceived delays that represents the time difference between the first perceived tap and the last one is represented as ΔDelay. In order to assess the spatial error corresponding to the perceived delay spread, the different paths toward the receiver are computed. The path length covered by the signal is calculated by the below-mentioned equation (3):

$$‖ \vec{{TxU}_{0}} ‖ + ‖ \vec{{U}_{0} Rx} ‖ \qquad ( 3 )$$

Where, U₀ and U₁ represents two distinct points on the DCS 106 The above-mentioned equation can be simplified, and rewritten as:

$${‖ \vec{{U}_{0} Rx} ‖}^{2} = {‖ \vec{{U}_{0} F} + \vec{FRx} ‖}^{2} = {‖ \vec{{U}_{0} F} ‖}^{2} + {‖ \vec{FRx} ‖}^{2} + 2 \vec{{U}_{0} F} \cdot \vec{FRx} \qquad ( 4 )$$

This can be written for any point U on the DCS 106 and specifically for U₀ and U₁ as

$${‖ \vec{{U}_{0} Rx} ‖}^{2} = {‖ \vec{{U}_{0} F} ‖}^{2} + {‖ \vec{FRx} ‖}^{2} + 2 \vec{{U}_{0} F} \cdot \vec{FRx} \qquad ( 5 )$$

$${‖ \vec{{U}_{1} Rx} ‖}^{2} = [ {‖ \vec{{U}_{1} F} ‖}^{2} + {‖ \vec{FRx} ‖}^{2} ] + 2 \vec{{U}_{1} F} \cdot \vec{FRx} \qquad ( 6 )$$

Combining the two expressions, as mentioned in the equation (5) and equation (6), as shown below in equation (7).

$${‖ \vec{{U}_{1} Rx} ‖}^{2} - {‖ \vec{{U}_{0} Rx} ‖}^{2} = [ {‖ \vec{{U}_{1} F} ‖}^{2} + {‖ \vec{FRx} ‖}^{2} - {‖ \vec{{U}_{0} F} ‖}^{2} - {‖ \vec{FRx} ‖}^{2} ] + 2 ( \vec{{U}_{1} F} \cdot \vec{FRx} - \vec{{U}_{0} F} \cdot \vec{FRx} ) \qquad ( 7 )$$

By factorizing the left-hand expression, the equation (7) is simplified as:

$$( ‖ \vec{{U}_{1} Rx} ‖ - ‖ \vec{{U}_{0} Rx} ‖ ) ( ‖ \vec{{U}_{1} Rx} ‖ + ‖ \vec{{U}_{0} Rx} ‖ ) = {‖ \vec{{U}_{1} F} ‖}^{2} - {‖ \vec{{U}_{0} F} ‖}^{2} + 2 ( \vec{{U}_{1} {U}_{0}} \cdot \vec{FRx} ) \qquad ( 8 )$$

On the other hand, the delay spread is calculated as shown below in equation (9), and in equation (10):

$$c ΔDelay = d ( Tx , {U}_{1} , Rx ) - d ( Tx , {U}_{0} , Rx ) = ‖ \vec{{TxU}_{1}} ‖ + ‖ \vec{{U}_{1} Rx} ‖ - ‖ \vec{{TxU}_{0}} ‖ - ‖ \vec{{U}_{0} Rx} ‖ \qquad ( 9 )$$

$$And ,$$

$$‖ \vec{{U}_{1} Rx} ‖ + ‖ \vec{{U}_{0} Rx} ‖ = \sqrt{{‖ \vec{{U}_{1} F} + \vec{FRx} ‖}^{2}} + \sqrt{{‖ \vec{{U}_{0} F} + \vec{FRx} ‖}^{2}} = ‖ \vec{{U}_{1} F} ‖ \sqrt{1 + \frac{{‖ \vec{FRx} ‖}^{2}}{{‖ \vec{{U}_{1} F} ‖}^{2}} + 2 \vec{FRx} \cdot \frac{\vec{{U}_{1} F}}{{‖ \vec{{U}_{1} F} ‖}^{2}}} \sqrt{1 + \frac{‖ \vec{FRx} ‖}{{‖ \vec{{U}_{1} F} ‖}^{2}} + 2 \vec{FRx} \cdot \frac{\vec{{U}_{1} F}}{{‖ \vec{{U}_{1} F} ‖}^{2}}} + ‖ \vec{{U}_{0} F} ‖ \sqrt{1 + \frac{{‖ \vec{FRx} ‖}^{2}}{{‖ \vec{{U}_{0} F} ‖}^{2}} + 2 \vec{FRx} \cdot \frac{\vec{{U}_{0} F}}{{‖ \vec{{U}_{0} F} ‖}^{2}}} \sqrt{1 + \frac{‖ \vec{FRx} ‖}{{‖ \vec{{U}_{0} F} ‖}^{2}} + 2 \vec{FRx} \cdot \frac{\vec{{U}_{0} F}}{{‖ \vec{{U}_{0} F} ‖}^{2}}} \qquad ( 10 )$$

After two first-order Taylor expansions to remove the square roots, the equation is rewritten as a new equation (11):

$$‖ \vec{{U}_{1} Rx} ‖ + ‖ \vec{{U}_{0} Rx} ‖ \approx ‖ \vec{{U}_{1} F} ‖ \sqrt{1 + 2 \vec{FRx} \cdot \frac{\vec{{U}_{1} F}}{{‖ \vec{{U}_{1} F} ‖}^{2}}} + ‖ \vec{{U}_{0} F} ‖ \sqrt{1 + 2 \vec{FRx} \cdot \frac{\vec{{U}_{0} F}}{{‖ \vec{{U}_{0} F} ‖}^{2}}} \approx ‖ \vec{{U}_{1} F} ‖ ( 1 + \vec{FRx} \cdot \frac{\vec{{U}_{1} F}}{{‖ \vec{{U}_{1} F} ‖}^{2}} ) + ‖ \vec{{U}_{0} F} ‖ ( 1 + \vec{FRx} \cdot \frac{\vec{{U}_{0} F}}{{‖ \vec{{U}_{0} F} ‖}^{2}} ) \approx ( ‖ \vec{{U}_{1} F} ‖ + \vec{FRx} \cdot \frac{\vec{{U}_{1} F}}{‖ \vec{{U}_{1} F} ‖} ) + ( ‖ \vec{{U}_{0} F} ‖ + \vec{FRx} \cdot \frac{\vec{{U}_{0} F}}{‖ \vec{{U}_{0} F} ‖} ) \qquad ( 11 )$$

The equation can be rewritten as a new equation (12):

$$( c ΔDelay - ‖ \vec{{TxU}_{1}} ‖ + ‖ \vec{{TxU}_{0}} ‖ ) ( ( ‖ \vec{{U}_{1} F} ‖ + \vec{FRx} \cdot \frac{\vec{{U}_{1} F}}{‖ \vec{{U}_{1} F} ‖} ) + ( ‖ \vec{{U}_{0} F} ‖ + \vec{FRx} \cdot \frac{\vec{{U}_{0} F}}{‖ \vec{{U}_{0} F} ‖} ) ) \approx {‖ \vec{{U}_{1} F} ‖}^{2} - {‖ \vec{{U}_{0} F} ‖}^{2} + 2 \vec{{U}_{1} {U}_{0}} \cdot \vec{FRx} \qquad ( 12 )$$

Finally combining all components provides a closed-form expression of the error, as shown below in equation (13).

$${\underbrace{c ΔDelay}}_{Measured quantity} {\overbrace{( ‖ \vec{{U}_{1} F} ‖ + ‖ \vec{{U}_{0} F} ‖ )}}^{\begin{matrix}Constant terms \\ Depends on the selected codeword\end{matrix}} \approx {\underbrace{{‖ \vec{{U}_{1} F} ‖}^{2} - {‖ \vec{{U}_{0} F} ‖}^{2} + ( ‖ \vec{{TxU}_{1}} ‖ - ‖ \vec{{TxU}_{0}} ‖ ) ( ‖ \vec{{U}_{1} F} ‖ + ‖ \vec{{U}_{0} F} ‖ )}}_{\begin{matrix}Constant terms \\ Depends on the selected codeword\end{matrix}} + {{\underbrace{\overbrace{( 2 \vec{{U}_{1} {U}_{0}} - ( \overbrace{c ΔDelay}^{Measured quantity} - ‖ \vec{{TxU}_{1}} ‖ + ‖ \vec{{TxU}_{0}} ‖ ) ( \frac{\vec{{U}_{0} F}}{‖ \vec{{U}_{0} F} ‖} + \frac{\vec{{U}_{1} F}}{‖ \vec{{U}_{1} F} ‖} ) )} \cdot \vec{FRx}}}^{}}_{\begin{matrix}Focusing \\ Error term\end{matrix}} \qquad ( 13 )$$

Hence, the focusing error is provided as an inner product of \vec{U}·\vec{FRx}. In an implementation, the focusing error can be corrected by changing the direction of transmission of signal with respect to the DCS 106, such as by changing the angular deviation with respect to the vector \vec{U} as defined in equation (13). Thus, by changing the angular deviation, the direction of transmission of the signal is changed. Moreover, if the value of focusing error is greater than zero (i.e., if \vec{U}·\vec{FRx}>0), then the DCS 106 changes the codeword, such as \vec{FRx}=α\vec{U}; α<0. However, if the value of the focusing error is less than zero (i.e., if \vec{U}·\vec{FRx}<0), then the DCS 106 changes the codeword, such as \vec{FRx}=α\vec{U}; α>0. In addition, if the value of the focusing error is equal to zero (i.e., if \vec{U}·\vec{FRx}=0), then the focusing is achieved through the codeword that is selected by the DCS 106 The value of the selected α represents the step size of a displacement (e.g., α\vec{U}) required to be selected through a priori iterative process or adapted dynamically through the iterative process. In an example, a big step size prevents convergence, and a small step size requires more time for convergence. In an implementation, the iterative optimization and search process to compute the proper codeword is based on a gradient type of algorithm for defining the new focal point, and the used codeword is used to generate the codebook that is closest to the displacement. As a result, the DCS 106 is configured to achieve an optimal converging through the efficient and correct selection of the codeword.

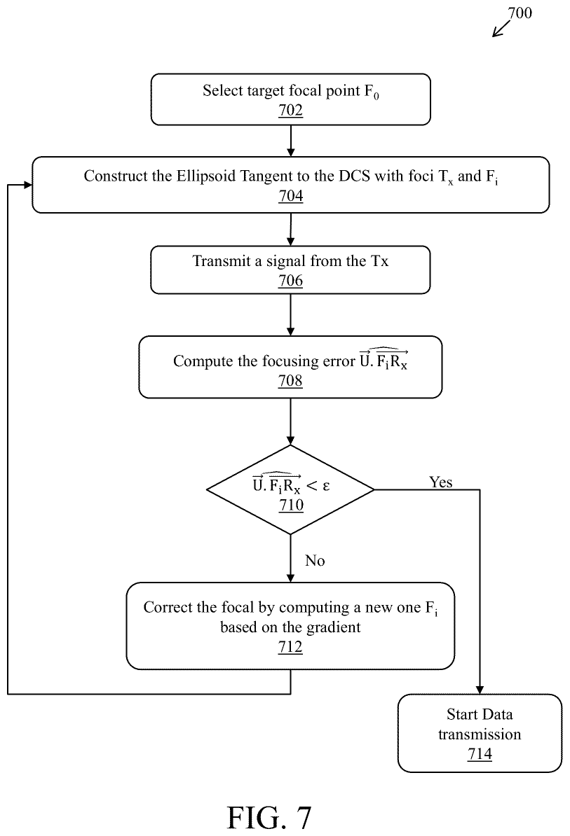

FIG. 7 is a flowchart that depicts a different operation for selecting a codeword for data transmission, in accordance with an embodiment of the present disclosure. FIG. 7 is shown in conjunction with elements from FIGS. 1A, 1B, 1C, 1D, 4, 5A, 5B, and 6. With reference to FIG. 7, there is shown a flowchart 700 that includes a series of operations from 702-to-714 The computer-based method 300 (of FIG. 3) is used to execute the flowchart 700 through the DCS 106 (of FIG. 1A).

At operation 702, the DCS 106 selects the target focal point F₀ (e.g., an initial focusing point) randomly or based on the prior information, such as the known positions of the two foci points location and the like, without limiting the scope of the present disclosure. Furthermore, at operation 704, the DCS 106 constructs the ellipsoid tangent to the DCS 106 with foci Tx and Fᵢ. Thereafter, at operation 706, the transmitter (e.g., the node 104) transmits the signal to the receiver (e.g., the node 108). The signal transmitted by the transmitter (e.g., the node 104) provides the necessary information to compute the focusing error (e.g., [symbol] ) to the receiver (e.g., the node 108) when the signal is perceived by the receiver. Further, the DCS 106 computes the focusing error (e.g., [symbol] ) at operation 708 Furthermore, at operation 710, the DCS 106 determines if the focusing error is less than a threshold error value (i.e., ∥ [symbol] ∥<ϵ). Thereafter, if the focusing error is below a threshold error value ϵ, then the DCS 106 is configured with the actual phase shift and provides efficient and improved focusing as compared to conventional approaches. Moreover, at operation 714, the data transmission is started from the transmitter (e.g., the node 104), to the receiver (e.g., the node 108). However, if the focusing error is not below a threshold error value ε (i.e., if ∥ [symbol] ∥ϵ), then the DCS 106 is not configured properly and is out of focus. Thus, the DCS 106 needs to be corrected by the α\vec{U}, and is used to compute the new focal point Fᵢ. Then the process starts over from operation 712 with the construction of the new ellipsoid based on the position update of new focal point Fᵢ and the known first focal Tₓ position. Thus, the above-mentioned operations (i.e., from operation 704 to operation 710) are repeated until the focusing error is below a threshold ϵ (i.e., convergence) to achieve efficient and improved data transmission.

FIG. 8 is a diagram that depicts an ellipsoid selection for codeword computation, in accordance with an embodiment of the present disclosure. FIG. 8 is shown in conjunction with elements from FIGS. 1A, 1B, 1C, 1D, 4, 5A, 5B, 6, and 7. With reference to FIG. 8, there is shown a diagram 800 that depicts the ellipsoid selection for the codeword computation of the ellipsoid for the configuration of the DCS 106

The diagram 800 shows a closed form of the ellipsoid that is derived from a geometrical construction, and the ellipsoid is selected to provide the required focusing properties for the configuration of the DCS 106 Furthermore, the diagram 800 shows the transmitter 404 with a focal F₁, the receiver 406 with a focal F₂, and the DCS 106 (i.e., represented as a square plane). The optimal ellipsoid ε* is constructed by taking the tangent to the DCS 106 in a point T 802 with the transmitter 404 and the receiver 406 through corresponding foci. In an implementation, a codeword cᵢ in a codebook, [symbol] focuses on the focal point Fᵢ in space through the DCS 106 and a swap vector \vec{F₁F₁₊₁} in a three-dimensional space. Furthermore, the DCS 106 identifies the new codeword (e.g., cᵢ₊₁∈ [symbol] ) that focuses on a focal point Fᵢ₊₁. Hence, the DCS 106 is configured to select the optimal codeword (e.g., c*∈ [symbol] *) that provides proper focusing from the transmitter 404 (i.e., a focal F₁) to the receiver 406 (i.e., a focal F₂) through the DCS 106 under the constraint of lacking knowledge of the placement of the various communicating elements, such as the transmitter 404, the receiver 406, and the DCS 106 Thus, every new codeword provides the optimal configuration of the DCS 106 to ensure convergence in the three-dimensional space.

FIG. 9 is a diagram that depicts an exemplary representation of an ellipsoid, in accordance with an embodiment of the present disclosure. FIG. 9 is shown in conjunction with elements from FIGS. 1A, 1B, 1C, 1D, 4, 5A, 5B, 6, 7, and 8. With reference to FIG. 9, there is shown a diagram 900 that depicts the exemplary representation of the ellipsoid.

The diagram 900 provides an example of the exemplary representation of the ellipsoid that is a tangent to a plane surface with specific foci points of the transmitter 404 (i.e., Tₓ) and the receiver 406 (i.e., Rₓ). The diagram 900 represents a geometrical representation based on simple geometrical operations. Firstly, the DCS 106 constructs a symmetric point Rₓ′ of the receiver 406 (i.e., Rₓ) with respect to the plane of the DCS 106 Thereafter, the point T, which is the tangent point of the ellipsoid with the plane of the DCS 106, is constructed at the intersection of the point of the transmitter 404 to the symmetric point Rx′ with the plane of the DCS 106 as represented in FIG. 12 through a dotted line. Finally, the ellipse is constructed with foci points Rx and the point Tx and passes through the point T by rotating the ellipse around its main axis (i. e., the point Rx and the point Tx). Thus, the ellipse is constructed to provide efficient and improved configurations for the DCS 106

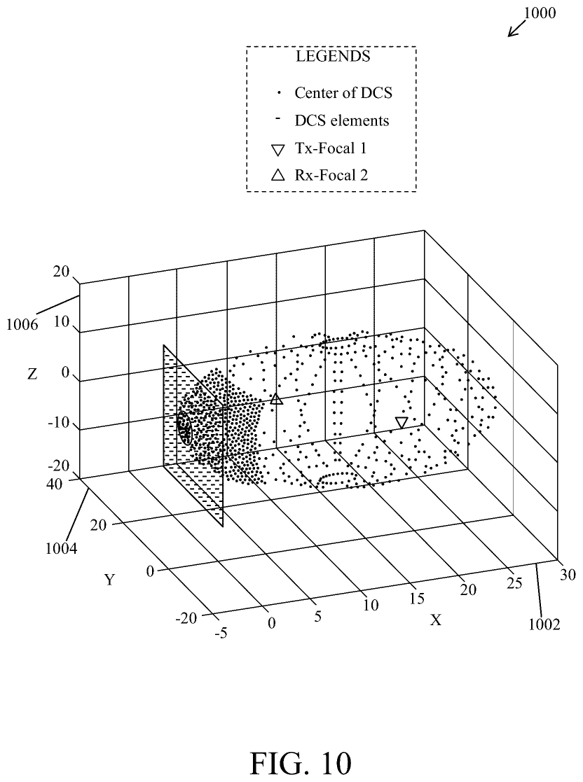

FIG. 10 is a three-dimensional (3D) graphical representation that depicts an equivalent point of an ellipsoid emulated by a digitally controllable scatterer (DCS) based on a computed phase shift matrix, in accordance with an embodiment of the present disclosure. FIG. 10 is shown in conjunction with elements from FIGS. 1A, 1B, 1C, 1D, 4, 5A, 5B, 6, 7, 8, and 9. With reference to FIG. 10, there is shown a 3D graphical representation 1000 that depicts the equivalent points of an ellipsoid that is emulated by the DCS 106 (of FIG. 1A) based on the computed phase shift matrix.

With reference to FIG. 10, there is shown the 3D graphical representation 1000 that includes an X-axis 1002 a Y-axis 1004, and Z-axis 1006 that are used to represent the equivalent points of the ellipsoid that is emulated by the DCS 106 based on a computed phase shift matrix. In an implementation, a codebook (i.e., a structured codebook or poset) is constructed through an explicit equation form of an ellipsoid that is compressed to generate a codeword. The codeword for a given point in space is simply generated by substituting the coordinates of a targeted point and coordinates of a focal, such as the focal of the transmitter 404 (or the focal of the receiver 406). In an implementation, the codebook is fixed and includes specific points in a space that are preselected to generate the codebook. However, a wise selection is required to be performed in order to describe an area that is covered by the DCS 106 Hence, for each equivalent point, the state of the DCS is computed and stored. In an example, the codebook is referred to as a lookup table or a 2D matrix of size S×| [symbol] |, where S is the number of scattering elements on the DCS 106 and | [symbol] | the cardinality of the codebook is the number of relevant points considered in the area. In another implementation, a closed form expression of the tangent ellipsoid that includes the coordinates of the two foci points and the equation defining a plane of the DCS 106 is used to compute the path difference for each scattering element M(x_{M}, y_{M}, z_{M}) and updating the phase shift correction ϕ_{M} to be applied. The closed form expression of the codeword for any foci points in the space and any point on the DCS 106 is defined by the corresponding Cartesian expression as shown below in equation (14).

$${ϕ}_{M} = f ( Tx , Rx , 𝒫 , M ∈ 𝒫 ) \qquad ( 14 )$$

The codebook requires no more storage or lookup tables as the value of the codeword could be instantaneously computed over the set of scattering elements M constituting the DCS 106 Furthermore, the codeword computation is simplified by considering real-world deployment scenarios and the underlying assumptions. The various points considered on the DCS 106 as reflecting elements are predefined as fixed components on the DCS 106 as the below-mentioned equation (15)

$${ϕ}_{M} = f ( Rx ) \qquad ( 15 )$$

Therefore, the equivalent points of the ellipsoid that is emulated are generated to provide the DCS 106 configurations to provide improved focusing between the transmitter 404 (e.g., the node 104) and the receiver 406 (e.g., the node 108) through an efficient and improved selection of the codeword.

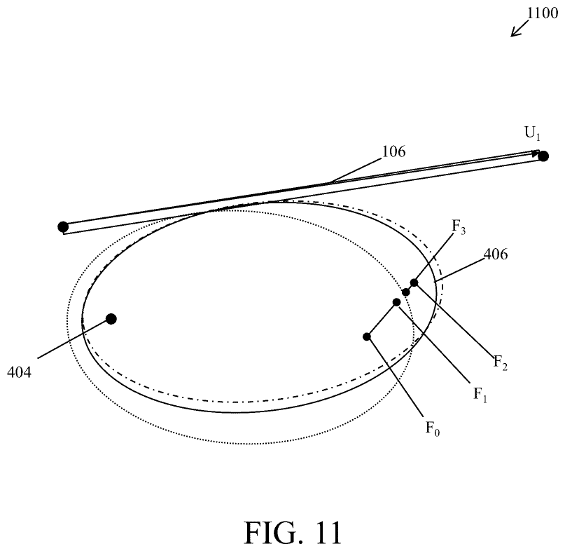

FIG. 11 is a diagram that depicts an exemplary focusing process for a digitally controllable scatterer (DCS), in accordance with an embodiment of the present disclosure. FIG. 11 is shown in conjunction with elements from FIGS. 1A, 1B, 1C, 1D, 4, 5A, 5B, 6, 7, 8, 9 and 10. With reference to FIG. 11, there is shown a diagram 1100 that depicts the exemplary focusing process for the DCS 106

The diagram 1100 represents the exemplary focusing (i.e., auto-focusing) process for the DCS 106 that is considered as an input and a well-structured poset codebook where an ordered relation between two given positions in a space (i.e., the focusing error) is related to a metric between two codewords in the codebook. In other words, the diagram 1100 represents two positions in space with an actual focusing point Fᵢ and an intended focusing point F_{∞}. However, it is possible to select the appropriate codeword for a second position given that the codeword focusing on a first position is known as well as an estimate of the error representing the spatial swap. Therefore, it is required to identify the optimal codeword c*∈ [symbol] that focuses the energy towards a targeted receiver, such as the receiver 406 with the unknown location. The process of auto-focusing requires selecting a random codeword and further configuring the DCS 106 according to the selected codeword. Therefore, such configuration sets the behavior of the DCS 106 like an ellipsoid as depicted in the FIG. 11 with dotted line 1102 and focuses the transmitted signal on a point F₀ in the space. Furthermore, the transmitter 404 transmits a signal that is further received by the receiver 406 In an implementation, the transmitter 404 is the node 104, and the receiver 406 is the node 108 In another implementation, the transmitter 404 is the node 108, and the receiver 406 is the node 104 The receiver 406 is configured to analyse the received signal and computes the perceived delay spread (i.e., ΔDelay). Based on the delay spread (i.e., ΔDelay), the known geometrical parameters of the transmitter 404, and the DCS 106, the focusing error is computed by the auto-focusing unit. In addition, the focusing error provides a gradient for the correction, which is a vector that provides the correct direction to search the receiver 406 Furthermore, a selection of an amplitude is performed to determine convergence speed. Therefore, based on the fully identified correction vector, the new focusing point is identified, such as a point F₁. Hence, the above-mentioned steps are repeated until convergence is achieved, and also to identify other focusing points, such as a point F₂ and a point F₃. The convergence is obtained when the delay spread is below a predefined threshold (i.e., ΔDelay≤ε). For example, in FIG. 11 the convergence is achieved after three iterations. Therefore, the convergence obtains the foci points that are on the same line by the construction of the ellipsoid.

FIG. 12 is a flowchart that depicts different operations for the exchange of messages between a digitally controllable scatterer (DCS) and two nodes, in accordance with an embodiment of the present disclosure. FIG. 12 is shown in conjunction with elements from FIGS. 1A, 1B, 1C, 1D, 4, 5A, 5B, 6, 7, 8, 9, 10 and 11. With reference to FIG. 12, there is shown a flowchart 1200 that includes a series of operations from 1202-to-1226 The flowchart 1200 depicts the exchange of messages between the DCS 106, the node 104, and the node 108 The DCS 106 is configured and managed by the node 104 (i.e., a transmitting node), such as a base station.

At operation 1202 the node 104 (i.e., the transmitter) acquires DCS parameters and a relative position of the DCS 106 Furthermore, at operation 1204, the node 104 sets the focal point F and constructs the ellipsoid at operation 1206 At operation 1208, the node 104 computes the codeword c, and computes the phases, ϕ used for configuring the DCS scattering elements. At operation 1210, the node 104 communicates the phase configuration ϕ to the DCS 106 (i.e., provide the codeword to the DCS 106 in order to apply the computed radiation pattern). Furthermore, at operation 1212 the DCS 106 configures the scattering pattern based on the provided phase configuration ¢ providing focusing towards the selected point F. Thereafter, at operation 1214, the node 104 transmits a signal to the node 108 (e.g., the receiver). After that, at operation 1216, the node 108 estimates the delay profile (i.e., ΔDelay) of the received signal and then sends the feedback about the delay profile (i.e., ΔDelay) to the node 104 (i.e., the transmitter), as shown at operation 1218 At operation 1220, the node 104 (i.e., the transmitter) computes the focusing error, such as \vec{U}·\vec{F₁Rₓ}. Moreover, at operation 1222 the node 104 is configured to determine if the value of the error is less than a predefined threshold value ¿ or not (i.e., if |\vec{U}·\vec{F₁Rₓ}|<ε). Thereafter, at operation 1224, the node 104 computes a new focal point F if the estimated error is not less than the predefined threshold value. At operation 1230, if the estimated absolute error such as |\vec{U}·\vec{F₁Rₓ}| is not less than the predefined threshold value ε, then the node 104 is configured to repeat the operation 1206 to the operation 1222 Thus, the node 104 performs all the operation, such as codeword computation, commanding and configuring the DCS 106, as well as the estimation of the focusing error and the correction process based on the newly computed focal point F. Finally, at operation 1228, if the calculated absolute error is less than the threshold value, then at operation 1226 node 104 may start a data communication session with node 108. Therefore, the optimal codeword is identified for focusing towards a target 108 with unknown position and may be used for establishing an efficient and improved data transmission.

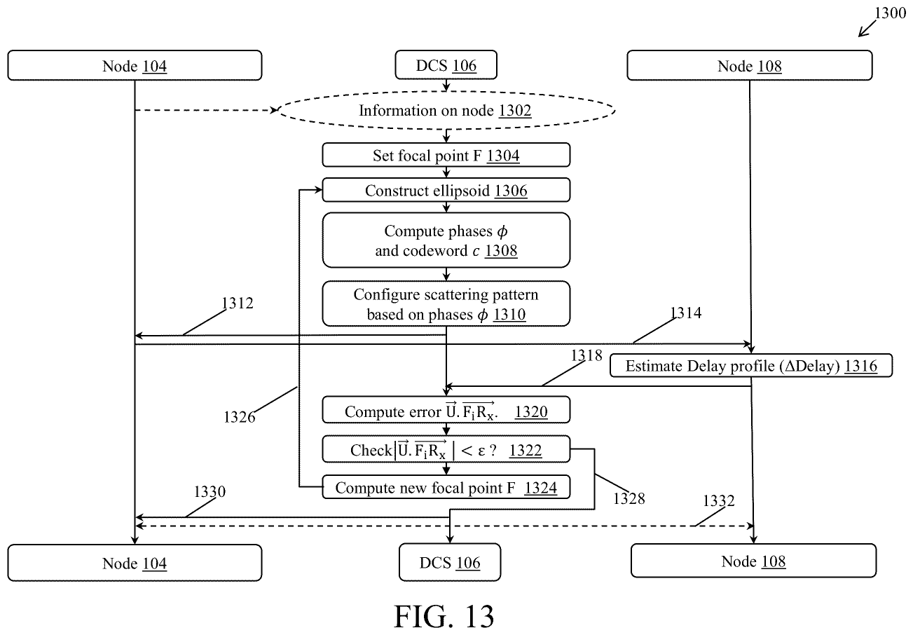

FIG. 13 is a flowchart that depicts different operations during the exchange of messages between a digitally controllable scatterer (DCS) and two nodes, in accordance with an embodiment of the present disclosure. FIG. 13 is shown in conjunction with elements from FIGS. 1A, 1B, 1C, 1D, 4, 5A, 5B, 6,7, 8, 9, 10, 11 and 12. With reference to FIG. 13, there is shown a flowchart 1300 that includes a series of operations from 1302-to-1332 The flowchart 1300 depicts the exchange of messages between the DCS 106, the node 104, and the node 108

At operation 1302, the DCS 106 retrieves an information on the node 104 (e.g., the transmitter), and further at operation 1304, the DCS 106 sets the focal point F. Furthermore, at operation 1306, the DCS 106 constructs the ellipsoid and computes the phase configuration, ϕ and the codeword c, such as at operation 1308 At operation 1310, the DCS 106 configures the scattering pattern based on the computed phases ϕ to provide focusing towards the selected focal point F. At operation 1312 the DCS 106 is configured and informs the node 104 by requesting the transmission of a signal. At operation 1314, the node 104 transmits a signal to the node 108 through the DCS 106 Thereafter, at operation 1316, the node 108 estimates the delay profile (i.e., ΔDelay), and at operation 1318, the node 108 sends feedback about the delay profile (i.e., ΔDelay) to the DCS 106 Furthermore, at operation 1320, the DCS 106 computes the focusing error, such as \vec{U}·\vec{F₁Rₓ} and determine if the absolute value of the error |\vec{U}·\vec{F₁Rₓ}| is less than a pre-set threshold value ε or not, such as at operation 1322 At operation 1324, the DCS 106 computes the new focal point F to reduce the estimated focusing error. if the condition |\vec{U}·\vec{F₁Rₓ}|<ε is not met. and at 1326 further executes the operations 1306 to 132. Moreover, If the |\vec{U}·\vec{F₁Rₓ}|<ε is true, then the DCS 106 determines that the DCS 106 is ready for providing the required focusing and performs operations 1328 and 1330 where it informs the transmitter 104 that the calibration for focusing on node 108 is done and that a communication sequence with node 108 can be started. Furthermore, at operation 1332 the node 104 starts the communication and data transfer to the node 108 Thus, the DCS 106 is configured to select the correct codeword and provide convergence through the configuration of the DCS 106 and, after that, perform the data transmission.

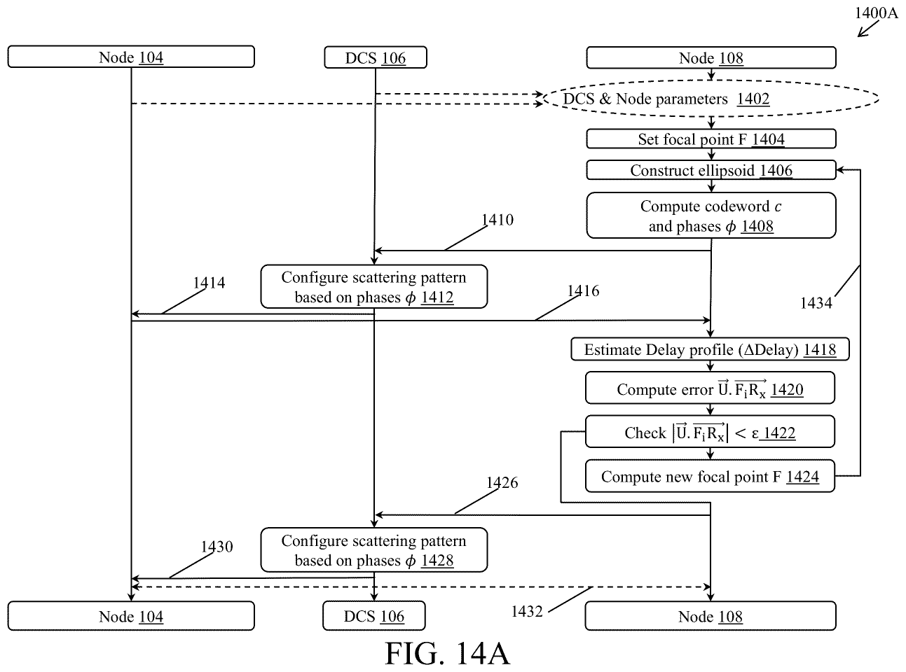

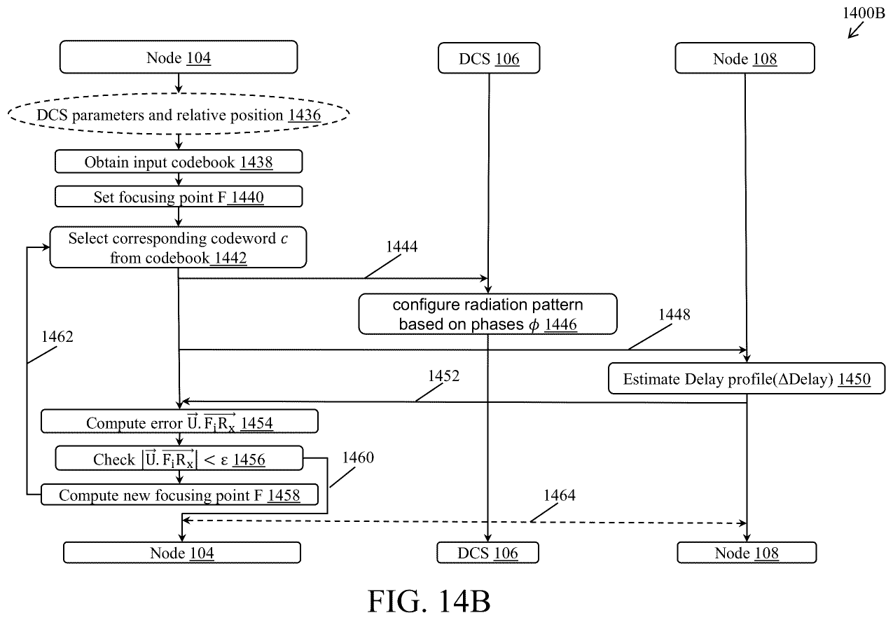

FIG. 14A is a flowchart that depicts different operations of processing at a node, in accordance with an embodiment of the present disclosure. FIG. 14A is shown in conjunction with elements from FIGS. 1A, 1B, 1C, 1D, 4, 5A, 5B 6, 7, 8, 9, 10, 11, 12, and 13. With reference to FIG. 14A, there is shown a flowchart 1400A that includes a series of operations from 1402-to-1434 The flowchart 1400A depicts the processing at the node 108 during an exchange of messages between the DCS 106, the node 104, and the node 108

At operation 1402 the node 108 (e.g., the receiver) retrieves an information about the node 104 (e.g., the transmitter) and the DCS 106 and their relative positions. Further, at operation 1404, the node 108 (e.g., the receiver) sets the focal point F. Furthermore, at operation 1406, the node 108 constructs the ellipsoid and at operation 1408 computes the codeword c and the phase configuration, ϕ. At operation 1410, the node 108 provides the phase configuration to the DCS 106, and at operation 1412 the DCS 106 configures the scattering pattern based on the received phases ϕ providing focusing towards F. At operation 1414, the DCS 106 requests a signal transmission from node 104 for calibration, and further at operation 1416, the node 104 transmits a signal to the node 108 Thereafter, at operation 1418, the node 108 estimates the delay profile (i.e., ΔDelay). Furthermore, the node 108 at operation 1420, computes a focusing error, such as \vec{U}·\vec{F₁Rₓ} and checks if the absolute value of the estimated error |\vec{U}·\vec{F₁Rₓ}| is less than a predefined threshold value ε or not at operation 1422 At operation 1424, the node 108 computes a new focal point F if the estimated absolute focusing error such as |\vec{U}·\vec{F₁Rₓ}| is not less than the pre-set threshold value ε and further at 1434 executes the steps mentioned in operations 1406 to 1422 If the condition |\vec{U}·\vec{F₁Rₓ}|<ε is true, then the node 108 performs operation 1426 where the DCS is informed of the final configuration and applies the final set of phases ϕ in order to generate the scattering pattern focusing on node 108 at 1428 At operation 1430, the DCS 106 informs the node 104 that the node 108 is ready for the transmission and the calibration for the data transmission is done. Furthermore, at operation 1432 the node 104 starts the communication and communication is established with node 108 through the DCS 106 Thus, the DCS 106 is configured to select the correct codeword and provide convergence through the configuration of the DCS 106 and, after that, perform the data transmission.

FIG. 14B is a flowchart that depicts different operations for the exchange of messages between a digitally controllable scatterer (DCS) and two nodes, in accordance with an embodiment of the present disclosure. FIG. 14B is shown in conjunction with elements from FIGS. 1A, 1B, 1C, 1D, 4, 5A, 5B, 6, 7, 8, 9, 10, 11, 12, 13 and 14A. With reference to FIG. 14B, there is shown a flowchart 1400B that includes a series of operations from 1436 to 1464 The flowchart 1400B depicts the exchange of messages between the DCS 106, the node 104, and the node 108 The DCS 106 is configured and managed by the node 104 (i.e., a transmitting node), such as a base station.

At operation 1436, the node 104 (i.e., the transmitter) collects DCS parameters and relative position of the DCS 106 Furthermore, at operation 1438 the node 104 obtains as input a codebook as a poset, and then selects a focusing point F at operation 1440 At operation 1442 the node 104 selects the codeword c from the codebook, codeword c corresponding to focal point F. Thereafter, at operation 1444, the node 104 provides the codeword, i.e. DCS phases ϕ related to codeword c to the DCS 106 Furthermore, at operation 1446, the DCS 106 configures the scattering pattern based on the received phases ϕ. Thereafter, at operation 1448 the node 104 transmits the signal to the node 108 (e.g., the receiver). After that, at operation 1450, the node 108 estimates the delay profile (i.e., ΔDelay) and then sends the feedback about the delay profile (i.e., ΔDelay) to the node 104 (i.e., the transmitter), as shown at operation 1452 At operation 1454, the node 104 (i.e., the transmitter) computes a focusing error, such as \vec{U}·\vec{F₁Rₓ}. Moreover, at operation 1456, the node 104 is configured to determine if the absolute value of the error is less than a pre-set threshold value or not (i.e., if |\vec{U}·\vec{F₁Rₓ}|<ε). Thereafter, at operation 1458, the node 104 computes a new focusing point F if the calculated absolute value of the focusing error is not less than the pre-set threshold value ε. At operation 1458, if the calculated error such as |\vec{U}·\vec{F₁Rₓ}| is not less than the threshold value ε, then the node 104 is configured to execute operation 1462 to repeat the operation 1442 to the operation 1456 Thus, the node 104 performs all the operation, such as codeword selection, commanding and configuring the DCS 106, as well as the estimation of the focusing error and the correction process. Therefore, the optimal codeword is identified for optimal focusing and consequently efficient and improved data transmission. In an example, the operations can be performed by the node 108 In addition, at operation 1460, if the calculated absolute value of the focusing error such as |\vec{U}·\vec{F₁Rₓ}| is less than a pre-defined threshold value ε, the node 104 starts the data communication and transfers the signal to the node 108 through operation 1464

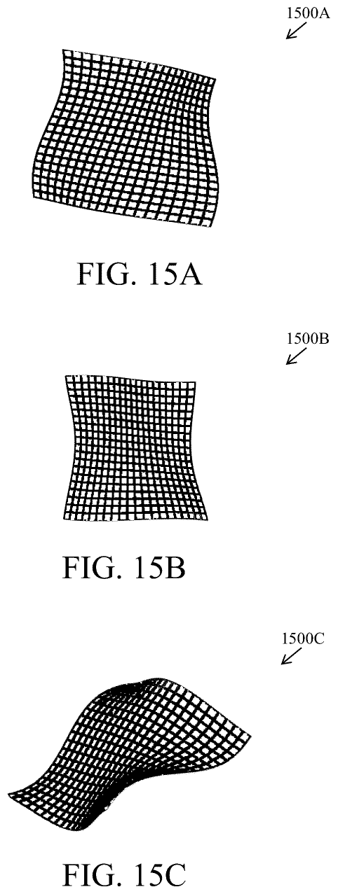

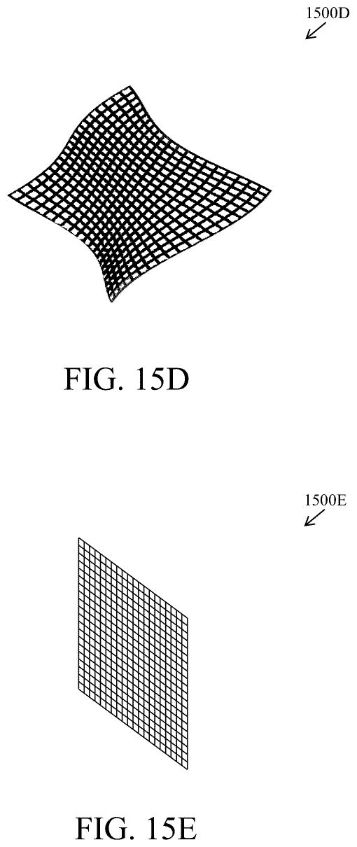

FIGS. 15A to 15E are different diagrams that depicts different exemplary configurations of scattering surfaces of a digitally controllable scatterer (DCS), in accordance with different embodiments of the present disclosure. FIGS. 15A to 15E are shown in conjunction with elements from FIGS. 1A, 1B, 1C, 1D, 4, 5A, 5B 6, 7, 8, 9, 10, 11, 12, 13 and 14. With reference to FIG. 15A, there is shown a diagram 1500A that depicts an exemplary configuration of scattering surface (i.e., non-planar shape) of the DCS 106. With reference to FIG. 15B, there is shown a diagram 1500B that depicts another exemplary configuration of scattering surface (i.e., non-planar shape) of the DCS 106 With reference to FIG. 15C, there is shown a diagram 1500C that depicts yet another exemplary configuration of scattering surface (i.e., non-planar shape) of the DCS 106 With reference to FIG. 15D, there is shown a diagram 1500D that depicts another exemplary configuration of scattering surface (i.e., non-planar shape) of the DCS 106 With reference to FIG. 15E, there is shown a diagram 1500E that depicts yet another exemplary configuration of scattering surface (i.e., planar shape) of the DCS 106 Alternatively stated, the DCS 106 may have different configurations or different shapes. For instance, the DCS 104 may have either a planar or a non-planar structure.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural. The word “exemplary” is used herein to mean “serving as an example, instance or illustration”. Any embodiment described as “exemplary” is not necessarily to be construed as preferred or advantageous over other embodiments or to exclude the incorporation of features from other embodiments. The word “optionally” is used herein to mean “is provided in some embodiments and not provided in other embodiments”. It is appreciated that certain features of the present disclosure, which are, for clarity, described in the context of separate embodiments, may also be provided in combination in a single embodiment. Conversely, various features of the invention, which are, for brevity, described in the context of a single embodiment, may also be provided separately or in any suitable combination or as suitable in any other described embodiment of the disclosure.

1. A computer-based method of configuring a digitally controllable scatterer for providing focusing between a first communication node having a known location and a second communication node having an unknown location, one of the first and second communication nodes being a transmitter Tₓ and the other one a receiver Rₓ, the method comprising the steps of
a) obtaining a structured codebook including a poset of codewords, each codeword designed to provide a focusing capability towards a possible focusing point in space, each codeword defining a respective phase shift configuration for the plurality of scattering elements of the digitally controllable scatterer, the poset ordered as a function of distance and direction between the possible focusing points,
b) selecting an initial codeword from the codebook to be used as a current codeword, said initial codeword being arranged to provide focusing towards a current focal point F_{c},
c) transmitting a signal from the transmitter and detecting a delay spread based on the received signal at the Rₓ,
d) determining a focusing error as a function of the detected delay spread,
e) if the focusing error is below a preset error threshold value, using the current codeword for configuring the digitally controllable scatterer, and ending the method,
f) if the focusing error is greater than the error threshold value, selecting a new focal point Fₙ as F_{c}, based on the estimated error and determining a new codeword from the codebook to provide focusing towards F_{c},
g) repeating steps c to f until the focusing error is below the preset error threshold value.

2. The method according to claim 1, wherein the estimated error is a vector having a slope, a direction and a magnitude.

3. The method according to claim 2, wherein the new focal point Fₙ is selected based on the slope and direction of the vector.

4. The method according to claim 3, wherein the new focal point Fₙ is further selected by setting the magnitude based on an iterative optimization algorithm.

5. A computer-based method of constructing a codebook comprising a poset of codewords for defining phase shifts for a digitally controllable scatterer, including for each of a number of sets of points Rₓ and Tₓ indicating possible positions for a receiver and a transmitter respectively, the method including determining at least a first and a second codeword according to the following:
obtaining a set [symbol] of points M, each point M being a point representing a position of a scattering element of the digitally controllable scatterer,
for each point M in the set [symbol] performing the following steps:
finding an ellipsoid ε* having Rₓ and Tₓ as foci points,
selecting a point M on the digitally controllable scatterer,
constructing an ellipse E as the intersection of the plane TxMRx with the ellipsoid,
computing a distance from the transmitter to the receiver through the point M, via a path intersecting the ellipse E in a point V between the point M and the receiver,
computing a distance from the transmitter to the receiver through the point V,
determining a phase compensation for the scatterer at point M based on the determined phase shift so that a signal along the path TxMRx will present the same phase when reaching Rₓ as a signal along the path TxVRx
determining a codeword based on the phase shifts for all points M in the set [symbol] ,
including the codeword in the codebook.

6. The computer-based method according to claim 5, wherein the phase compensation ϕ_{M} is determined as
$${ϕ}_{M} = \frac{2 {πδ}_{m}}{λ} ≡ \frac{2 π}{λ} ( ‖ \vec{TxM} ‖ + ‖ \vec{MRx} ‖ - ‖ \vec{TxV} ‖ - ‖ \vec{VRx} ‖ ) [ 2 π ] .$$

7. The computer-based method according to claim 5, wherein the ellipsoid ε* is constructed constructing a symmetric point F′_{c} of a current focal point F_{c} with respect to the plane of the digitally controllable scatterer,
constructing a point T at the intersection of the line F′_{c} Tₓ with the plane of the digitally controllable scatterer
constructing the ellipse with foci points F_{c}, Tₓ and passing through the point T
constructing the ellipsoid by rotating the ellipse around its main axis.
